(19) United States
(12) Patent Application Publication
(10) Pub. No.: US 2010/0200117 A1
(43) Pub. Date: Aug. 12, 2010

(54) Suction hood

(76) Inventors: Josef Glogger, Buchloe (DE); Herbert Ginter, Germaringen (DE); Ingo Loeschky, Kaufering (DE); Marion Loeschky, Kaufering (DE)

Correspondence Address: ABELMAN, FRAYNE & SCHWAB, 666 THIRD AVENUE, 10TH FLOOR, NEW YORK, NY, 10017, US

(21) Appl. No.: 12/655,736

(22) Filed: Jan. 5, 2010

(30) Foreign Application Priority Data
Jan. 8, 2009 (DE) 10 2009 000 084.4

(51) Int. Cl. B23Q 11/00

(52) U.S. Cl. 144/252.1

(57) ABSTRACT

A suction hood for drillings and drilling dust produced during drilling has a base body (12) union (14) for connection with a hose of a vacuum source and projecting from the base body (12), at least one sealing element (23) for sealing the opening (15) formed in the base body (12) and having a through-opening (22) for a tool; and a holding member (31) for securing the at least one sealing element (23) on the base body (12) with the base body (12) having a securing section (16) projecting therefrom and on which the holding member (31) is securable without use of any tool.

### BACKGROUND OF THE INVENTION

1. Field of the Invention

The present invention relates to a suction hood for drillings and drilling dust produced during drilling and having a base body with a receiving space, a union for connection with a hose of a vacuum source and projecting from the base body, at least one sealing element for sealing an opening formed in the base body and having a through-opening for a tool, and a holding member for clamping the at least one sealing element on the base body in a mounted condition of the holding member.

2. Description of the Prior Art

During drilling of boreholes in a constructional component such as, e.g., a ceiling or a wall, with a power tool, e.g., a hand-held hammer drill, drillings and drilling dust are produced and which can contaminate the surrounding space. Even during cleaning of a formed borehole, e.g., for chemical anchoring of a fastening element with a clearing device such as brush-off device or blast-off device, drillings and drilling dust are produced which contaminate the surrounding space.

In order to prevent contamination of the surrounding space during the works mentioned above, European Publication EP 0 799 674 A1 proposes a suction hood having a base body that surrounds a receiving space. A connection union for connection with a hose of a vacuum source projects from the base body. In the base body, there is provided an opening that is sealed with a sealing device having a through-opening for a working tool. As a sealing element, the sealing device includes a slotted diaphragm with a through-opening for the working tool and a ring as a holding element for securing the sealing element on the base body. In a mounted condition of the ring, the sealing element is clamped between the ring and the base body. For securing the sealing element, the ring is secured to the base body with screws.

A hose of a vacuum source such as a vacuum cleaner is secured on the connection union, and the suction hood is positioned at a corresponding location of the constructional component. A working tool is inserted through the through-opening in the sealing element and is brought in a contact with the constructional component before formation of a bore, and both the power tool and the vacuum source are actuated. The drillings and the drilling dust penetrate into the receiving space and are aspirated therefrom as a result of an underpressure produced by the vacuum source. The sealing element insures that almost no drillings and drilling dust would inadvertently escape in the vicinity of the working tool and contaminate the surrounding space.

The drawback of the known suction hood consists in that after a certain service life, the sealing element can wear off and cannot insure an appropriate sealing of the base body opening to prevent escaping drillings and drilling dust. In addition, a false air can penetrate into the receiving space of the base body, which reduces the suction capacity. For replacing a worn sealing element, the screws, which secure the holding member, need be released with a tool and be again screwed in after a new sealing element is arranged on the base body. This process is expensive and requires a suitable tool.

Accordingly, an object of the present invention is to provide a suction hood for drillings and drilling dust produced during drilling in which the sealing elements are easily replaceable when needed.

### SUMMARY OF THE INVENTION

This and other objects of the present invention, which will become apparent hereinafter, are achieved by providing, on the base body, a securing section projecting therefrom and on which the holding member is securable without use of any tool.

With the holding member, which is securable on the base body without using any tool, the worn-off sealing element can be easily removed from outside and be replaced with another similar or different sealing element securable on the base body. E.g., the sealing element can be formed as a diaphragm with an opening and of a plastic material or as a member provided with a plurality of brush elements between which a through-opening for a working tool is formed. Dependent on type and size of the working tool, at least one sealing element, which was adapted to the working tool, can be easily, without any auxiliary tool, secured on the hood.

Advantageously, the securing section is provided at a side of the base body remote from the receiving space. As a result, the holding member is easily securable from outside for clamping the at least one sealing element.

Advantageously, the securing section and the holding member form parts of a bayonet arrangement. Thereby, by pivoting the holding member over a small angle, the sealing element can be easily placed on or removed from the base body. Advantageously, the securing section is formed of several engaging-from-behind section elements, and the holding member has a corresponding number of projections advantageously provided with a clamping profile and which are at least partially engaged by the engaging-from-behind section elements in a mounted condition of the holding member.

Alternatively, the securing section can have a threaded portion, e.g., an inner thread, with the holding member having a correspondingly formed counter-threaded portion, e.g., an outer thread that is screwable with the inner thread.

Advantageously, there are provided more than one sealing elements securable on the base body with an offset with respect to each other. Each sealing element is aligned differently relative to the inserted working tool, so that a reliable sealing of the base body opening is insured even with larger tools.

Advantageously, the sealing elements are identically formed. This permits to produce a large number of sealing elements by mass production which insures a cost-effective production of the sealing elements.

Alternatively, different sealing elements, which distinguish from each other by the material and a material thickness, can be combined with each other.

By varying the number of the sealing elements, their material, and arrangement of the sealing elements with respect to each other, the user can, without using any tool, adapt the sealing to respective applications.

Advantageously, a plurality of fixing pins projects from the base body around the opening, and the at least one sealing element has a plurality of aligned openings through which the corresponding fixing pins extend. During the arrangement of the at least one sealing element on the base body, the fixing elements, which project from the base body outwardly, i.e., remotely from the receiving space, reliably define at least one position of the at least one sealing element on the base body. Advantageously, the fixing pins are arranged radially circumferentially about the center of the base body opening equi-distantly from each other, whereby the at least one sealing element can be pivotally arranged about a corresponding angular region. The number of the aligned openings corresponds to the number of fixing pins. When more than one sealing element is provided, the fixing pins and the aligned openings insure proper alignment of each sealing element, e.g., a predetermined offset arrangement of the sealing elements on the base body with respect to each other.

Advantageously, the at least one sealing element has, in plan view, a circular shape and includes a plurality of lamellas that form slots extending from a center of the at least one sealing element radially outwardly short of an outer circumference of the sealing element. The lamellas are easily deflectable upon insertion, of the working tool and are in a closed contact with the outer side of the working tool during a drilling process. This insures an advantageous sealing during operation of the power tool. Advantageously, the sealing element is formed of a flexible elastic material, so that the sealing elements returns to its initial position after the working tool have been removed.

Advantageously, the sealing element is formed as a diaphragm and, preferably, of a plastic material.

Advantageously, the aligned openings are arranged at an outer angle to each other that deviates from an inner angle at which the lamella-formed slots are arranged relative to each other. Thereby, in particular with an offset arrangement of several sealing elements, no axial overlapping of slots occurs.

Advantageously, a center opening is provided in the at least one sealing element. This insures an easy insertion of a working tool in the section hood.

The novel features of the present invention, which are considered as characteristic for the invention, are set forth in the appended claims. The invention itself, however, both as to its construction and its mode of operation, together with additional advantages and objects thereof, will be best understood from the following detailed description of preferred embodiment, when read with reference to the accompanying drawings.

### BRIEF DESCRIPTION OF THE DRAWINGS

The drawings show:

FIG. 1 a perspective view of a section hood according to the present invention;

FIG. 2 a cross-sectional view of the inventive suction hood; and

FIG. 3 a plan view of sealing members arranged on the base body.

Basically, in the figure the same elements are designated with the same reference numerals.

### DETAILED DESCRIPTION OF THE PREFERRED EMBODIMENT

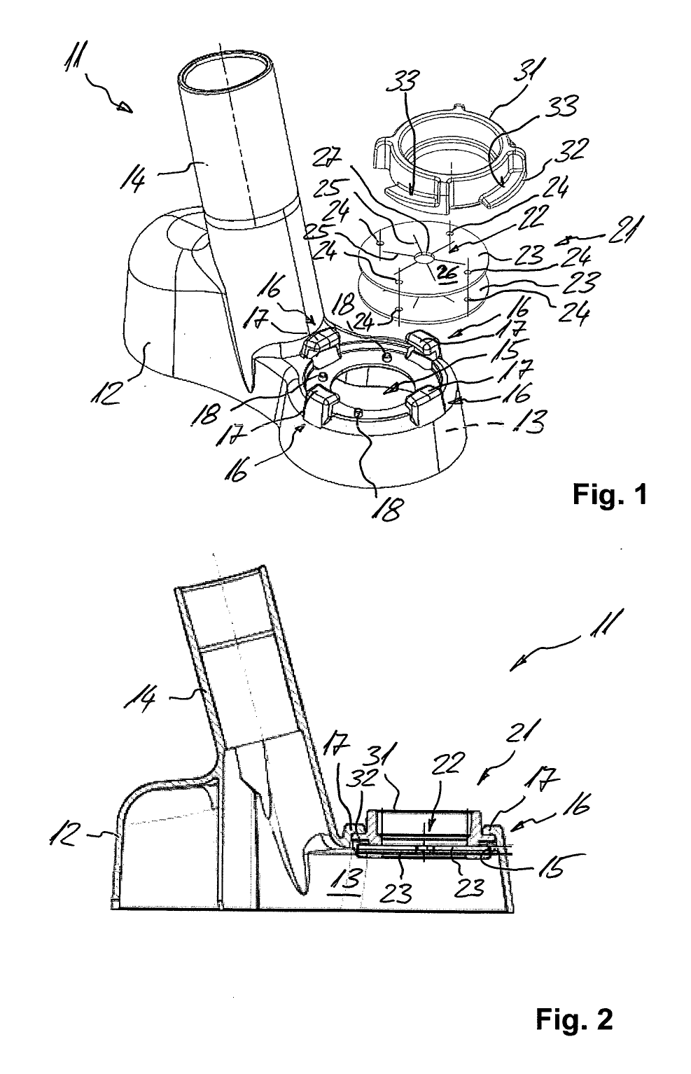

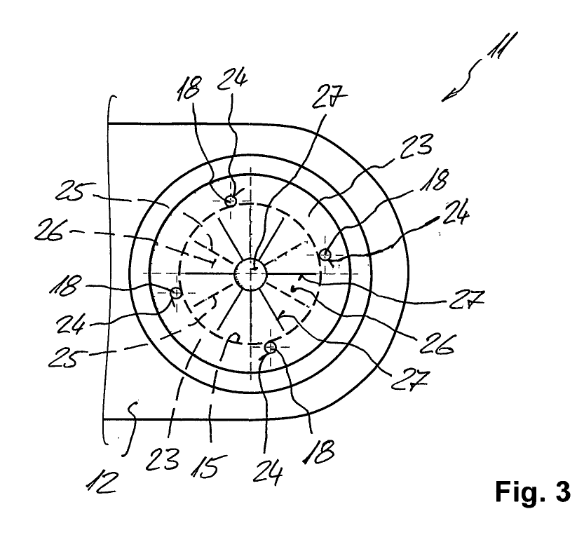

A suction hood 11 according to the present invention which is shown in FIGS. 1-3 and which is used for protecting a surrounding environment from drillings and drilling dust produced during drilling, has a base body 12 that covers a receiving space 13. A connection union 14 for connection with a hose of a vacuum source, not shown here, projects from the base body 12. In the base body 12, there is further provided an opening 15 on which a sealing element 21 is arranged. The sealing element 21 has a through-opening 22 for a working tool, not shown here. The sealing element 21 includes two identically formed sealing members 23 with each having a through-opening 22 for the working tool and which are offset relative to each other, and a holding member 31 for securing the sealing elements 23 on the base body 12.

A securing section 16 projects upwardly from the base body 12 at a side of the base body 12 remote from the receiving space 13. A holding member 31 is mountable on the securing section 16, without use of any tool. The securing section 16 and the holding member 31 form part of a bayonet locking arrangement. To this end, the securing section 16 is formed of four, circumferentially arranged and equidistantly spaced from each other, section elements 17. The holding member 31 has four, radially projecting, engaged from behind, projections 32 which extend circumferentially about an angular region of less than 90° and correspond to respective section elements 17.

On a side 33 of the projections 32, remote from the base body 12 in the mounted condition of the holding member 31, there is provided a clamping profile so that the thickness of the projections 32 increases from their respective free ends. Upon rotation of the holding element 31 by an angle of maximum 90°, the sides 33 of the projections 32, which are provided with the clamping profile, become engaged with the engaging-from-behind section elements 17, clamping the sealing elements 23 between the holding member 31 and the base body 12.

At a side of the base body 12 remote from the receiving space, around the opening 15, four, circumferentially equidistantly spaced, fixing pins 18 project from the base body 12. The sealing elements 23 have, respectively, four, circumferentially equidistantly spaced, aligned openings 24 through which the fixing pins 18 project in the mounted condition of the holding member 31.

The sealing elements 23 have, in plan view, a circular shape and lamellas 26 which form slots 25 extending radially outwardly from the center somewhat short of the circumference of the sealing element 23. The sealing elements 23 are formed as diaphragm from a plastic material. The aligned openings 24 are arranged at an outer angle of 90° to each other and that deviates from an inner angle of 60° at which the slots 25 of the lamellas 26 are arranged to each other. In the center of the sealing element 23, a center opening 27 is provided.

Though the present invention was shown and described with references to the preferred embodiment, such is merely illustrative of the present invention and is not to be construed as a limitation thereof and various modifications of the present invention will be apparent to those skilled in the art. It is therefore not intended that the present invention be limited to the disclosed embodiment or details thereof, and the present invention includes all variations and/or alternative embodiments within the spirit and scope of the present invention as defined by the appended claims.

What is claimed is:

1. A suction hood for drillings and drilling dust produced during drilling, comprising a base body (12) having a receiving space (13), a union (14) for connection with a hose of a vacuum source and projecting from the base body (12), and an opening (15); at least one sealing element (23) for sealing the opening (15) and having a through opening (22) for a tool; and a holding member (31) for securing the at least one sealing element (23) on the base body (12), the sealing element (23) being clamped between the holding member (31) and the base body (12) in a mounted condition of the holding member (31), the base body (12) having a securing section (16) projecting therefrom and on which the holding member (31) is securable without use of any tool.

2. A suction hood according to claim 1, wherein the securing section (16) is provided at a side of the base body (12) remote from the receiving space (13).

3. A suction hood according to claim 1, wherein the securing section (16) and the holding member (31) from parts of a bayonet arrangement.

4. A suction hood according to claim 1, comprising a further sealing element (23) offset with respect to the at least one sealing element (23).

5. A suction hood according to claim 4, wherein the at least one and further sealing elements (23) are identically formed.

6. A suction hood according to claim 1, wherein a plurality of fixing pins (18) project from the base body (12) around the opening (15), and the at least one sealing element (23) has a plurality of aligned openings (24) through which the corresponding fixings pins extend.

7. A suction hood according to claim 6, wherein the at least sealing element (23) has, in plan view, a circular shape and includes a plurality of lamellas (26) that form slots (25) extending from a center of the at least one sealing element (23) radially outwardly short of an outer circumference of the sealing element (23).

8. A suction hood according to claim 7, wherein the aligned openings (24) are arranged at an outer angle to each other that deviates from an inner angle at which the lamella-formed slots (25) are arranged.

9. A suction hood according to claim 1, wherein a center opening (27) is provided in the at least one sealing element.
